(19) United States
(12) Patent Application Publication
(10) Pub. No.: US 2013/0212712 A1
(43) Pub. Date: Aug. 15, 2013

(54) SYSTEM AND METHOD FOR CREATING BOUNDED PACKETS OF PERSONALLY-IDENTIFIABLE INFORMATION (PII)

(71) Applicant: KEVIN Richard BROCK, Leesburg, VA (US)

(72) Inventor: KEVIN Richard BROCK, Leesburg, VA (US)

(21) Appl. No.: 13/766,650

(22) Filed: Feb. 13, 2013

Related U.S. Application Data
(60) Provisional application No. 61/598,151, filed on Feb. 13, 2012.

(51) Int. Cl. H04L 29/06

(52) U.S. Cl. CPC H04L 63/04
USPC 726/30

(57) ABSTRACT

A system and method is disclosed, which allows registered visitors the opportunity to create bounded packets (QYouBs) containing a range of personally-identifiable information (PII) selected by the subscriber to meet a specific need, which can then be quickly transferred to a receiving party.

### FIELD OF THE INVENTION

This disclosure is generally directed to the field of information technology and personally identifiable information (PII).

### BACKGROUND OF THE INVENTION

The need for people to share personally identifiable information (PII) is both frequent and growing. This type of information can range from not-so-sensitive to very sensitive. The following are a few examples of how (PII) is currently exchanged: (i) Two businessmen meet and exchange physical business cards typically identifying for whom each works, title, address, phone number, and email, Each takes the card back to his office and loads the information either by hand or scanner into his Outlook contact list;
(ii) An individual needs to provide directions to her home to a visitor or repairman, etc. She can provide verbal directions over the phone or send an email with her address. The recipient then enters the information in Google Maps or into their GPS device;
(iii) A new patient to a doctor's office arrives early to fill out multiple forms asking for name, address, phone number, emergency contacts, DOB, POB, etc, which he dutifully handwrites into the form;
(iv) A customer shops online and repeatedly types in common identifying information usually required by the vendor such as name, billing address, email and payment information; and,
(v) A job seeker completes multiple applications for employment either in person or online repeatedly typing in a host of PII.

While the frequency to share (PII) is growing there remains the need by individuals to manage and control the security of such information.

### BRIEF DESCRIPTION OF DRAWINGS

Preferred and alternative examples of the present invention are described in detail below with reference to the following drawings:

FIG. 1 is a flow chart illustrating various steps in accordance with a method of the present invention.

FIG. 2 is a continuation of the flow chart of FIG. 1 illustrating various steps in accordance with a method of the present invention.

### DETAILED DESCRIPTION OF THE PREFERRED EMBODIMENT

An embodiment of the present invention relates generally to the interactive process that enables the creation of a specialized packet of PII, its interoperability with other existing technologies, its agile manipulation, and processes for easy sharing.

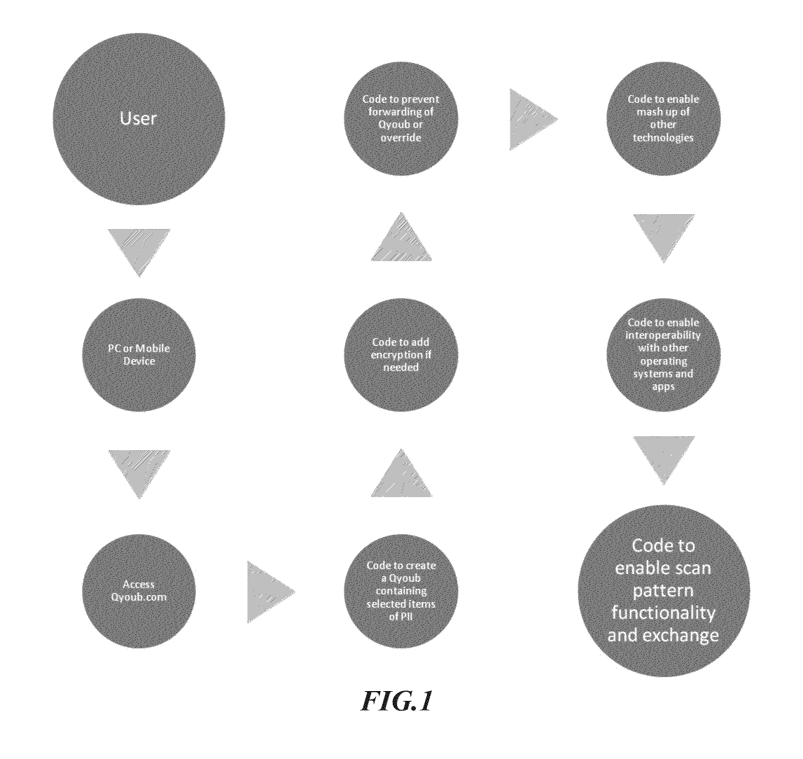

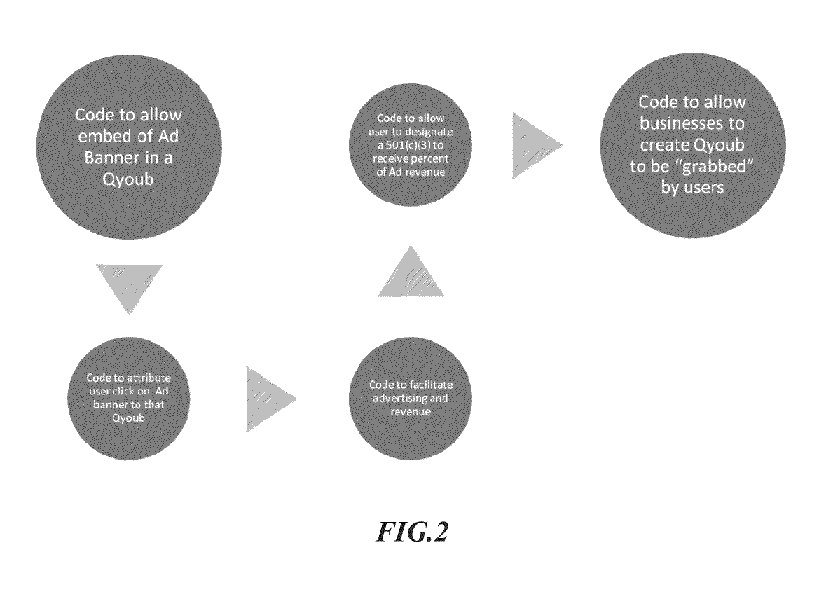

In accordance with a preferred embodiment and with reference to FIGS. 1 and 2, the present invention contributes to optimally advantageous social interaction and networking by providing a means to speed up and make more agile, fulsome, and secure the exchange of PII that average users find necessary on a frequent daily basis. It helps eliminate air gaps that currently exist in the exchange process when an exchange necessitates an additional step such as downloading Obtained information into other applications (or apps) including, but not limited to: Outlook®, Google Maps®, GPS. The process makes exchanges seamless and automated. It also reduces handwritten, redundant paperwork.

An embodiment of the present invention relates to the capability to manage identifier information in a series of bounded packets that the user designs and configures and assigns security protocols and, which may contain only the information the user intends to provide in a given situation. For example, a packet can be created for very basic information such as an email address or phone number. Another example of a packet might have additional information such as home address, map and UPS coordinates. Yet a third example of a packet might have this information plus a photo.

The packets created can have a range of increasingly sensitive information to a point at which the present invention can provide the ability to encrypt the information. This is an attractive option for information such as DOB, POB, SSN, credit card data, or even an electronic signature. These bounded packets are referred to as a QYouB™ (“cube”), a word picture that conveys their self-contained, manageable, agile, and portable nature. There can be different levels of these packets signifying the extent and sensitivity of the PII within and the amount of security needed. Usage possibilities are endless, and the following examples are provided for illustrative purposes:

Instead of exchanging paper business cards which then have to be scanned or copied into a contact list back at the office, two businessmen electronically exchange a QYouB™ containing all that would be included on a normal paper business card. This exchange is accomplished via any technology that allows data exchanges between electronic devices and, especially, mobile devices, i.e. smart phones. For example, an exchange is accomplished via an email, SMS, or, any technology that enables an exchange by holding near or touching a smartphone to another smartphone. The information contained in the business card QYouB™ can automatically upload, for example, to the recipient's Outlook contact list. This QYouB™ business card can also contain a link to a user's company website and perhaps even a photo and/or link to a short video of the cardholder introducing themselves and their role.

Another example involves the frequent need to provide directions to your home to a visitor or repairman. A QYouB™ containing an address and direct link to Google Maps can be transferred to the recipient, by, for example: email, SMS, or direct smartphone to smartphone exchange, and the coordinates downloaded directly to the recipient's smartphone UPS.

Yet another example includes configuring a QYouB™ with PII typically sought by certain vendors, e.g., doctor's offices, government offices, online vendors, etc. Eventually vendors will readily accept the transfer of a QYouB™ (“We're QYouB™ Friendly!”) in lieu of making the customer fill out data by hand.

In addition, a QYouB™ can be specifically programmed to sit in front of a smartphone password portal so that in case of phone loss or an emergency situation, contact information can be readily available or other important data such as blood type, medical conditions, religion, and emergency contact. A QYouB™ could also be utilized to assist in the identification of children or others who are not readily able to identify themselves. A QYouB™ is designed for exchange with any media that can contain the cube. Since the information concerns PII, albeit most of it of lower sensitivity, QYouB™ can be programmed to not allow forwarding. The QYouB™ owner, however, can override that default setting. While a QYouB™ can have immediate appeal and utility for private users, there are significant commercial applications as well. Businesses can make a QYouB™ available on their websites that contain contact information, location coordinates, and perhaps small ads that can be grabbed, i.e., downloaded by customers into their contact or favorite vendor lists.

Specialty coding enables the unique processes that allow user interaction and navigation on the website; user creation of different QYouB™ types; the mash up and leveraging of existing technologies to create interoperability within the QYouB™ and interoperability of the QYouB™ itself with outside applications, e.g., Microsoft Outlook®; the embedding of advertisement within the QYouB™ and ability to track clicks for revenue purposes; the application of encryption when needed; and the ability to share the QYouB™ via transmission options.

In accordance with yet another embodiment of the present invention, a website may provide a specific social networking service not currently available.

The website, which for example, may have the address “QYouB.com”, may offer registered visitors the opportunity to create bounded packets containing a range of personally identifiable information selected by the subscriber to meet a specific need, and that can then be quickly transferred to a receiving party.

There are numerous commercial opportunities for generating revenue in accordance with embodiments of the present invention, including by way of example:

(a) creating a subscription service, however, it may be preferable to make the service free to the user;

(b) advertising on the QYouB.com website, or even including a small banner ad in each QYouB™ created by a user could offer another revenue option with an additional follow up charge to the advertiser if the ad is clicked and the viewer taken to the advertiser website;

(c) since some users may be averse to having an ad embedded in their QYouB™, one idea is to give the user an option to create a QYouB™ without an ad embed, however the user could be incentivized to allow an ad if assured that QYouB™ would divert a predetermined fraction of ad revenue to a favored 501(c)(3) charity and leverage users to push advertising deeper downstream; and

(d) commercial entities could be charged for creating a QYouB™ that they make available on their website and a “Grab my QYouB™” would encourage a site visitor to download a small packet of information containing contact information, location coordinates, map, and perhaps a small ad or link to an ad.

While a preferred and alternative embodiments of the invention have been illustrated and described, as noted above, many changes can be made without departing from the spirit and scope of the invention. Accordingly, the scope of the invention is not limited by the disclosure of the embodiments, but rather, the spirit and scope of the invention is defined by the following claims.

I claim:

1. A method for managing personal identifier information, comprising the steps of:
creating at least one bounded packet of personal identifier information, and
assigning security protocols to the bounded packed permitting a user to manage the personal identifier information for a particular situation and to exchange that packet with another.
